(19) United States
(12) Patent Application Publication
(10) Pub. No.: US 2010/0285402 A1
(43) Pub. Date: Nov. 11, 2010

(54) TONER AND METHOD OF MANUFACTURING TONER

(76) Inventors: Akinori Saitoh, Numazu-shi (JP); Masahide Yamada, Numazu-shi (JP); Hiroshl Yamada, Numazu-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/776,645

(22) Filed: May 10, 2010

(30) Foreign Application Priority Data
May 8, 2009 (JP) 2009-113522

(51) Int. Cl. G03G 9/087; G03G 9/08; G03G 5/00

(52) U.S. Cl. 430/109.4; 430/105; 430/110.4; 430/137.1

(57) ABSTRACT

A toner is provided which includes a first binder resin, a second binder resin that is a reaction product of a compound having an active hydrogen group with a polymer reactive with the active hydrogen group, a colorant, and a release agent. The toner includes the second binder resin in an amount of from 6.4 to 40.9% by weight, and the reaction product includes organic-solvent-insoluble components in an amount of from 20 to 95% by weight. A method of manufacturing the toner is also provided.

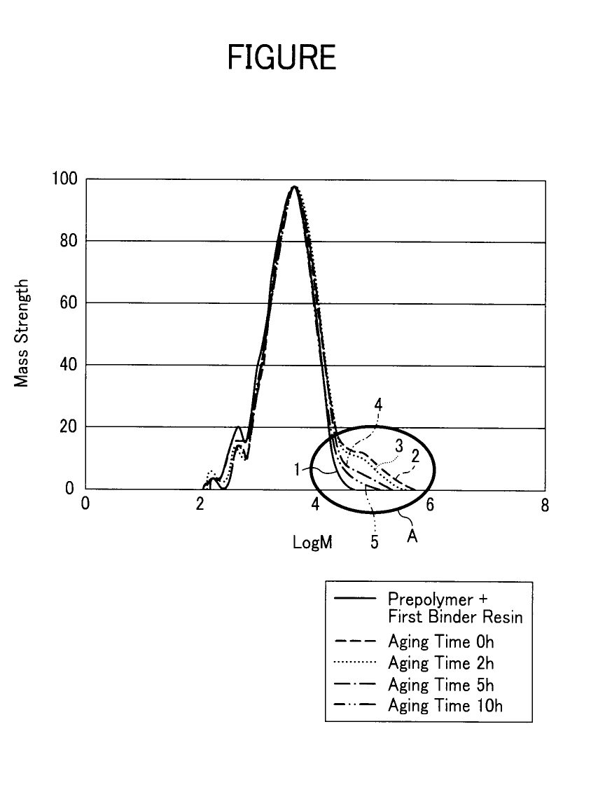

### CROSS-REFERENCE TO RELATED APPLICATIONS

The present patent application claims priority pursuant to 35 U.S.C. §119 from Japanese Patent Application No. 2009-113522, filed on May 8, 2009, which is hereby incorporated by reference herein in its entirety.

### BACKGROUND

1. Field of the Invention

The present invention relates to a toner for developing an electrostatic image formed on a photoreceptor into a toner image in electrophotography and electrostatic recording, and to a method of manufacturing the toner.

2. Description of the Background

Recently, toners are required to be much smaller and be fixable at much lower temperatures than heretofore in view of image quality and energy saving requirements. In particular, the warm-up period of an image forming apparatus, during which a surface of a heating member is heated from room temperature to a temperature capable of fixing a toner on a recording medium, is required to be much shorter to reduce electrical energy consumption. In a case where toner particles are manufactured through kneading and pulverizing processes, the resulting toner particles have irregular shapes and a broad particle size distribution. Such toner particles require a large amount of energy when fixed on a recording medium, which may disadvantageously lengthen the warm-up period and increase electrical energy consumption. Also, the toner particles manufactured through kneading and pulverizing processes have a large amount of a release agent such as a wax on the surfaces thereof, which may disadvantageously contaminate image forming members such as carriers, photoreceptors, and/or blades while facilitating separation of the toner particles from a fixing member.

To overcome the above-described disadvantages of toner particles manufactured through kneading and pulverizing processes, various polymerization processes for manufacturing toner particles have been proposed. Polymerization processes are generally capable of producing much smaller toner particles with a narrower particle size distribution compared to the kneading and pulverizing processes. Polymerization processes are also capable of including a release agent in the resulting toner particles.

For example, Japanese Patent Application Publication Nos. 11-133665, 2002-287400, and 2002-351143 each disclose a toner manufactured through a polyaddition process of a polyester prepolymer having an isocyanate group with an amine in the presence of an organic solvent and an aqueous medium. In this case, carboxyl groups of polyester are likely to interfere with the elongating or cross-linking reaction between the prepolymer and the amine, destabilizing the degree of the polyaddition. The resulting toner may be poor at low-temperature fixing and may not be resistant to high-temperature offset.

Japanese Patent Application Publication Nos. 63-109447 and 2001-158819 each disclose a polyester for use as toner binder having a reliable molecular weight distribution, which is manufactured through what is called an aging process for giving the resulting polyester satisfactory low-temperature fixability and hot-temperature offset resistance. The aging process is easily applicable to typical condensation polymerization, which is a high-temperature reaction for manufacturing polyester, but is difficult to apply to the above-described polyaddition process conducted in the presence of an organic solvent and an aqueous medium.

### SUMMARY

Exemplary aspects of the present invention are put forward in view of the above-described circumstances, and provide a novel toner for developing an electrostatic latent image.

In one exemplary embodiment, the novel toner includes a first binder resin, a second binder resin, a colorant, and a release agent. The second binder resin is a reaction product of a compound having an active hydrogen group with a polymer reactive with the active hydrogen group. The toner includes the second binder resin in an amount of from 6.4 to 40.9% by weight. The reaction product includes organic-solvent-insoluble components in an amount of from 20 to 95% by weight.

Other exemplary aspects of the present invention are put forward in view of the above-described circumstances, and provide a novel method for manufacturing toner.

In one exemplary embodiment, the novel method includes dissolving or dispersing a first binder resin, a compound having an active hydrogen group, a polymer reactive with the active hydrogen group, a colorant, and a release agent in an organic solvent to prepare a toner components liquid; dispersing the toner components liquid in an aqueous medium containing a particulate resin to prepare oil droplets, while reacting the compound having an active hydrogen group with the polymer reactive with the active hydrogen group to form a second binder resin; removing the organic solvent from the oil droplets to prepare a toner; and washing and drying the toner. The toner thus manufactured includes the second binder resin in an amount of from 6.4 to 40.9% by weight. The reaction product includes organic-solvent-insoluble components in an amount of from 20 to 95% by weight.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGURE shows molecular weight distribution curves of toners as a result of a GPC measurement, with varying the aging time of the reaction under a constant reaction temperature.

### DETAILED DESCRIPTION

An exemplary aspect of the present invention provides a toner having both low-temperature fixability and high-temperature offset resistance, which comprises a first binder resin, a second binder resin that is a reaction product of a compound having an active hydrogen group with a polymer reactive with the active hydrogen group, a colorant, and a release agent. The reaction product includes a specific amount of organic-solvent-insoluble components.

Specifically, the toner includes the second binder resin in an amount of from 6.4 to 40.9% by weight based on total weight of the toner. When the amount of the second binder resin is too small, high-temperature offset resistance of the resultant toner may be poor. When the amount of the second binder resin is too large, low-temperature fixability of the resultant toner may be poor.

The reaction product includes organic-solvent-insoluble components in an amount of from 20 to 95% by weight based on total weight of the reaction product. In other words, the reaction between the compound having an active hydrogen group and the polymer reactive with the active hydrogen group is controlled so that the production rate of organic-solvent-insoluble components is 20 to 95% by weight. When the amount of the organic-solvent-insoluble components is too small, high-temperature offset resistance of the resultant toner may be poor. When the amount of the organic-solvent-insoluble components is too large, low-temperature fixability of the resultant toner may be poor.

The production rate of organic-solvent-insoluble components in the reaction between the compound having an active hydrogen group and the polymer reactive with the active hydrogen group is determined as follows.

First, 0.3 g of the toner is subjected to soxhlet extraction with 165 ml of an organic solvent used for the toner manufacture (e.g., ethyl acetate) for 7 hours. After drying the extraction residue at 60° C. for 12 hours, the weight R (g) of the extraction residue is measured. The extract residue rate G (% by weight) is calculated from the following equation (1):

R/0.3×100=G (1)

Next, the extraction liquid is subjected to GPC (i.e., gel permeation chromatography) to measure a molecular weight distribution of components included in the extraction liquid.

Specifically, after removing the organic solvent from the extraction liquid under reduced pressures, an appropriate amount of tetrahydrofuran (i.e., THF containing a stabilizer, from Wako Pure Chemical Industries, Ltd.) is added thereto so that the resulting sample liquid includes the components in an amount of 0.15% by weight. After passing a filter with 0.2-μm openings, 100 μl of the sample liquid is injected into a measuring instrument under the following conditions.

Measuring instrument: GPC-8220GPC (from Tosoh Corporation)

Columns: TSKgel SuperHZM-H 15 cm×3 (from Tosoh Corporation)

Measurement temperature: 40° C.

Solvent: THF Flow rate: 0.35 ml/min

A molecular weight distribution of the components included in the extraction liquid is determined from a calibration curve created from several kinds of monodisperse polystyrene standard samples, which correlates the logarithm of molecular weight to the number of counts of a detector (e.g., a refractive index detector). Usable monodisperse polystyrene standard samples include Showdex STANDARD No. S-7300, S-210, S-390, S-875, S-1980, S-10.9, S-629, S-3.0, and S-0.580 (from Showa Denko K.K.), and toluene, for example.

Thus, a molecular weight distribution curve of the components included in the extraction liquid (hereinafter “soxhlet-extracted components”) is obtained. In the same manner, the first binder resin is solely subjected to the above measurement to obtain a molecular weight distribution curve of the first binder resin.

A molecular weight distribution curve is generally defined with a lateral axis representing logarithm of molecular weight (hereinafter “Log M”) and a vertical axis representing mass strength.

The molecular weight distribution curve of the soxhlet-extracted components has a mass strength peak which results from the first binder resin at a specific Log M. The molecular weight distribution curve of the soxhlet-extracted components is converted so that said mass strength peak is coincident with that observed in the molecular weight distribution curve of the first binder resin, and then both molecular weight distribution curves are overlapped on one another. Thereafter, with regard to the molecular weight distribution curve of the soxhlet-extracted components, the sum T of the mass strength at each Log M is calculated. Further, the sum D of the mass strength difference between the molecular weight distribution curves of the soxhlet-extracted components and the first binder resin at each Log M beyond said peak is calculated.

The ratio L (% by weight) of the first binder resin and the ratio H (% by weight) of the second binder resin, i.e., the reaction product of the compound having an active hydrogen group and the polymer reactive with the active hydrogen group based on the soxhlet-extracted components are calculated from the following equations (2) and (3):

100−H=L (2)

D/T×100=H (3)

Further, the following equations (4) and (5) are satisfied:

(A−X):(B−Y)=L:H (4)

X+Y=G−Z (5)

wherein:
A (% by weight) represents the ratio of the first binder resin based on the toner;
B (% by weight) represents the ratio of the second binder resin based on the toner;
Z (% by weight) represents the ratio of the remaining components other than the first and second binder resins based on the toner;
X (% by weight) represents the ratio of the first binder resin remaining in the extraction residue (i.e., organic-solvent-insoluble components in the first binder resin) based on the toner;
Y (% by weight) represents the ratio of the second binder resin remaining in the extraction residue (i.e., organic-solvent-insoluble components in the second binder resin) based on the toner;
G (% by weight) represents the ratio of the extraction residue based on the toner;
L (% by weight) represents the ratio of the first binder resin based on the soxhlet-extracted components; and
H (% by weight) represents the ratio of the second binder resin based on the soxhlet-extracted components.

The ratio X (% by weight) of the first binder resin remaining in the extraction residue based on the toner and the ratio Y (% by weight) of the second binder resin remaining in the extraction residue based on the toner are calculated from the equations (4) and (5).

The production rate P (% by weight) of organic-solvent-insoluble components through the reaction between the compound having an active hydrogen group and the polymer reactive with the active hydrogen group, i.e., the ratio P (% by weight) of organic-solvent-insoluble components based on the reaction product is determined from the following equation (6):

Y/B×100=P (6)

A more specific example will be described below. In a case in which “the compound having an active hydrogen group” is an amine compound, “the polymer reactive with the active hydrogen group” is a prepolymer having an isocyanate group, and “the organic solvent” is ethyl acetate, the production rate P (%) of organic-solvent-insoluble components is determined as follows.

First, as described above, the toner is subjected to soxhlet extraction with ethyl acetate. The extraction liquid is then subjected to GPC to measure a molecular weight distribution of components included in the extraction liquid. FIGURE shows molecular weight distribution curves as a result of the GPC measurement of the extraction liquid, with varying the aging time of the reaction under a constant reaction temperature. In FIGURE, a curve 1 represents a molecular weight distribution of the first binder resin and the prepolymer which is unreacted; and curves 2 to 5 represent molecular weight distributions of the first binder resin and the second binder resin when the aging time is 0, 2, 5, and 10 hours, respectively. An encircled portion A in FIGURE shows a fact that as the aging time becomes longer, the amount of the unreacted prepolymer and the second binder resin with low polymerization degree, i.e., organic-solvent-soluble components, becomes smaller; and the amount of the second binder resin with high polymerization degree, i.e., organic-solvent-insoluble components, becomes greater. Then a ratio h (% by weight) of organic-solvent-insoluble components to organic-solvent-soluble components is calculated from the curve difference observed in the encircled portion A.

In a case in which the ratio A (% by weight) of the first binder resin based on the toner is 82.5, the ratio B (% by weight) of the second binder resin based on the toner is 17.5, and the ratio Z (% by weight) of the remaining components based on the toner is 0, the following equations (7) and (8) are satisfied:

(82.5−X):(17.5−Y)=(1−h):h (7)

G=X+Y (8)

wherein:
X (% by weight) represents the ratio of the first binder resin remaining in the extraction residue (i.e., organic-solvent-insoluble components in the first binder resin) based on the toner;
Y (% by weight) represents the ratio of the second binder resin remaining in the extraction residue (i.e., organic-solvent-insoluble components in the second binder resin) based on the toner; and
G (% by weight) represents the ratio of the extraction residue based on the toner.

Since h and G are actually measurable, Y is calculated from the equations (7) and (8).

The production rate P (% by weight) of organic-solvent-insoluble components through the reaction between the amine compound and the prepolymer, i.e., the ratio P (% by weight) of organic-solvent-insoluble components based on the reaction product is determined from the following equation (9):

P=Y/17.5×100 (9)

In the above-described case, the production rate P becomes between 20 and 95% when the aging time is 1 hour or more at a reaction temperature of 100° C. or less.

Preferably, the polymer reactive with the active hydrogen group has a weight average molecular weight of from 10,000 to 200,000, to obtain a toner having low-temperature fixability and high-temperature offset resistance. When the weight average molecular weight is too small, it is difficult to control the reaction speed, which may affect manufacture stability. When the weight average molecular weight is too large, the polymer may not react very well and the high-temperature offset resistance of the resultant toner may be poor.

The above-described toner is obtained by dispersing an oil phase comprising toner components and/or toner component precursors in an aqueous medium. More specifically, the toner is obtained by dissolving or dispersing a first binder resin, a compound having an active hydrogen group, a polymer reactive with the active hydrogen group, a colorant, and a release agent in an organic solvent, to prepare a toner components liquid (i.e., the oil phase); dispersing the toner components liquid in an aqueous medium containing a particulate resin to prepare oil droplets, while reacting the compound having an active hydrogen group with the polymer reactive with the active hydrogen group to form a second binder resin; removing the organic solvent from the oil droplets to prepare toner particles; and washing and drying the toner particles.

The polymer reactive with the active hydrogen group may be a reactive modified polyester (RMPE), for example. Specific examples of RMPE include, but are not limited to, a polyester prepolymer (A) having an isocyanate group.

The reactive modified polyester (RMPE) is subjected to cross-linking and/or elongating reactions with an amine or a diisocyanate compound (e.g., diphenylmethane diisocyanate) to form the second binder resin.

For example, the polyester prepolymer (A) having an isocyanate group reacts with an amine (B) to form a urea-modified polyester (i.e., the second binder resin). Because the molecular weight is easily controllable, such a urea-modified polyester is suitable for a toner to be fixable at low temperatures without fixing oil. Moreover, in a case in which a toner includes the urea-modified polyester, undesired adhesion of the toner to a fixing member can be suppressed while keeping high fluidity and high transparency of the toner.

A polyester prepolymer can be obtained by introducing a functional group to terminal active hydrogen groups (e.g., an acid group, a hydroxyl group) of a polyester. When the functional group that is introduced to the terminal active hydrogen groups of a polyester is an isocyanate group, the resulting polyester prepolymer will be the polyester prepolymer (A) having an isocyanate group. Such a polyester prepolymer derives a modified polyester (MPE), specifically, the polyester prepolymer (A) having an isocyanate group derives a urea-modified polyester (UMPE). Preferably, the toner includes the urea-modified polyester (UMPE) obtained from cross-linking and/or elongation reactions of the polyester prepolymer (A) having an isocyanate group with the amine (B) as the second binder resin.

The polyester prepolymer (A) having an isocyanate group can be obtained by reacting a polyester, which is a polycondensation product of a polyol (PO) with a polycarboxylic acid (PC), having an active hydrogen group with a polyisocyanate (PIC). The active hydrogen group may be a hydroxyl group (e.g., an alcoholic hydroxyl group, a phenolic hydroxyl group), an amino group, a carboxyl group, or a mercapto group, for example. Among these groups, an alcoholic hydroxyl group is most preferable.

The polyol (PO) may be a diol (DIO) or a polyol (TO) having 3 or more valences, for example. Preferably, the polyol (PO) is a diol (DIO) alone or a mixture of a diol (DIO) with a small amount of a polyol (PO).

Specific examples of the diol (DIO) include, but are not limited to, alkylene glycols (e.g., ethylene glycol, 1,2-propylene glycol, 1,3-propylene glycol, 1,4-butanediol, 1,6-hexanediol); alkylene ether glycols (e.g., diethylene glycol, triethylene glycol, dipropylene glycol, polyethylene glycol, polypropylene glycol, polytetramethylene ether glycol); alicyclic diols (e.g., 1,4-cyclohexanedimethanol, hydrogenated bisphenol A); bisphenols (e.g., bisphenol A, bisphenol F, bisphenol S); alkylene oxide (e.g., ethylene oxide, propylene oxide, butylene oxide) adducts of the above alicyclic diols; and alkylene oxide (e.g., ethylene oxide, propylene oxide, butylene oxide) adducts of the above bisphenols. Among these compounds, an alkylene glycol having 2 to 12 carbon atoms and an alkylene oxide adduct of a bisphenol are preferable; and an alkylene oxide adduct of a bisphenol alone and a mixture of an alkylene oxide adduct of a bisphenol with an alkylene glycol having 2 to 12 carbon atoms are more preferable.

Specific examples of the polyol (TO) having 3 or more valences include, but are not limited to, polyvalent aliphatic alcohols having 3 or more valences (e.g., glycerin, trimethylolethane, trimethylolpropane, pentaerythritol, sorbitol); polyphenols having 3 or more valences (e.g., trisphenol PA, phenol novolac, cresol novolac); and alkylene oxide adducts of the above polyphenols having 3 or more valences.

The polycarboxylic acid (PC) may be a dicarboxylic acid (DIC) or a polycarboxylic acid (TC) having 3 or more valences, for example. Preferably, the polycarboxylic acid (PC) is a dicarboxylic acid (DIC) alone or a mixture of a dicarboxylic acid (DIC) and a small amount of a polycarboxylic acid (TC) having 3 or more valences.

Specific examples of the dicarboxylic acid (DIC) include, but are not limited to, alkylene dicarboxylic acids (e.g., succinic acid, adipic acid, sebacic acid); alkenylene dicarboxylic acids (e.g., maleic acid, fumaric acid); and aromatic dicarboxylic acids (e.g., phthalic acid, isophthalic acid, terephthalic acid, naphthalene dicarboxylic acid). Among these compounds, alkenylene dicarboxylic acids having 4 to 20 carbon atoms and aromatic dicarboxylic acids having 8 to 20 carbon atoms are preferable.

Specific examples of the polycarboxylic acid (TC) having 3 or more valences include, but are not limited to, aromatic polycarboxylic acids having 9 to 20 carbon atoms (e.g., trimellitic acid, pyromellitic acid).

The polycarboxylic acid (PC) may also be an acid anhydride or a lower alkyl ester (e.g., methyl ester, ethyl ester, isopropyl ester) of the above-described dicarboxylic acids (DIC) and the polycarboxylic acids (TC) having 3 or more valences.

The equivalent ratio ([OH]/[COOH]) of hydroxyl groups [OH] in the polyol (PO) to carboxyl groups [COOH] in the polycarboxylic acid (PC) is from 2/1 to 1/1, preferably from 1.5/1 to 1/1, and more preferably from 1.3/1 to 1.02/1.

Specific examples of the polyisocyanate (PIC) include, but are not limited to, aliphatic polyisocyanates (e.g., tetramethylene diisocyanate, hexamethylene diisocyanate, 2,6-diisocyanatomethyl caproate); alicyclic polyisocyanates (e.g., isophorone diisocyanate, cyclohexylmethane diisocyanate); aromatic diisocyanates (e.g., tolylene diisocyanate, diphenylmethane diisocyanate); aromatic aliphatic diisocyanates (e.g., α,α,α′,α′-tetramethylxylylene diisocyanate); isocyanurates; the above-described polyisocyanates blocked with a phenol derivative, an oxime, or a caprolactam; and mixtures thereof.

The equivalent ratio ([NCO]/[OH]) of isocyanate groups [NCO] in the polyisocyanate (PIC) to hydroxyl groups [OH] in the polyester is from 5/1 to 1/1, preferably from 4/1 to 1.2/1, and more preferably from 2.5/1 to 1.5/1. When the equivalent ratio ([NCO]/[OH]) is too large, low-temperature fixability of the resultant toner may be poor.

The polyester prepolymer (A) having an isocyanate group preferably has the polyisocyanate (PIC) unit in an amount of from 0.5 to 40% by weight, more preferably from 1 to 30% by weight, and most preferably from 2 to 20% by weight. When the amount of the polyisocyanate (PIC) unit is too small, high-temperature offset resistance, heat-resistant storage stability, and low-temperature fixability of the resultant toner may be poor. When the amount of the polyisocyanate (PIC) unit is too large, low-temperature fixability of the resultant toner may be poor.

The average number of isocyanate groups per molecule of the polyester prepolymer (A) is preferably 1 or more, more preferably from 1.5 to 3, and much more preferably from 1.8 to 2.5. When the number of isocyanate groups per molecule is too small, the molecular weight of the resulting urea-modified polyester may be too low and the resulting toner may have poor high-temperature offset resistance.

The amine (B) may be a diamine (B1), a polyamine (B2) having 3 or more valences, an amino alcohol (B3), an amino mercaptan (B4), an amino acid (B5), or a blocked amine (B6) in which the amino group in any of the amines (B1) to (B5) is blocked.

Specific examples of the diamine (B1) include, but are not limited to, aromatic diamines (e.g., phenylenediamine, diethyltoluenediamine, 4,4′-diaminodiphenylmetahne); alicyclic diamines (e.g., 4,4′-diamino-3,3′-dimethyldicyclohexylmethane, diamine cyclohexane, isophoronediamine); and aliphatic diamines (e.g., ethylenediamine, tetramethylenediamine, hexamethylenediamine).

Specific examples of the polyamine (B2) having 3 or more valences include, but are not limited to, diethylenetriamine and triethylenetetramine.

Specific examples of the amino alcohol (B3) include, but are not limited to, ethanolamine and hydroxyethylaniline.

Specific examples of the amino mercaptan (B4) include, but are not limited to, aminoethyl mercaptan and aminopropyl mercaptan.

Specific examples of the amino acid (B5) include, but are not limited to, aminopropionic acid and aminocaproic acid.

Specific examples of the blocked amine (B6) include, but are not limited to, ketimine compounds obtained from the above-described amines (B1) to (B5) and ketones (e.g., acetone, methyl ethyl ketone, methyl isobutyl ketone), and oxazoline compounds.

Among these amines (B), a diamine (B1) alone and a mixture of a diamine (B1) with a small amount of a polyamine (B2) having 3 or more valences are preferable.

The molecular weight of the resulting urea-modified polyester can be controlled by the use of an elongation terminator, if needed. Specific examples of usable elongation terminators include, but are not limited to, monoamines (e.g., diethylamine, dibutylamine, butylamine, laurylamine) and blocked monoamines (e.g., ketimine compounds).

The equivalent ratio ([NCO]/[NHx]) of isocyanate groups [NCO] in the prepolymer (A) to amino groups [NHx] in the amine (B) is from 1/2 to 2/1, preferably from 1.5/1 to 1/1.5, and more preferably from 1.2/1 to 1/1.2. When the equivalent ratio ([NCO]/[NHx]) is too large or small, the molecular weight of the resulting urea-modified polyester may be too low and the resulting toner may have poor high-temperature offset resistance.

The resulting urea-modified polyester (UMPE) may have urethane bonds other than the urea bonds. In this case, the molar ratio of urea bonds to urethane bonds is preferably from 100/0 to 10/90, more preferably from 80/20 to 20/80, and most preferably from 60/40 to 30/70. When the ratio of urea bonds is too small, high-temperature offset resistance of the resulting toner may be poor.

The urea-modified polyester (UMPE) preferably has a weight average molecular weight (Mw) of 10,000 or more, more preferably from 20,000 to 10,000,000, and most preferably from 30,000 to 1,000,000. When Mw is too small, high-temperature offset resistance of the resulting toner may be poor. Also, the urea-modified polyester (UMPE) preferably has a number average molecular weight (Mn) of from 1,000 to 10,000, and more preferably from 1,500 to 6,000.

In the process of manufacturing the toner, for example, the polyester prepolymer (A) having an isocyanate group, which is prepared by heating a polyol (PO) and a polycarboxylic acid (PC) to 150 to 280° C. in the presence of an esterification catalyst (e.g., tetrabutoxy titanate, dibutyltin oxide) while removing the produced water and reducing pressure to prepare a polyester having a hydroxyl group, and reacting the polyester having a hydroxyl group with a polyisocyanate (PIC) at 40 to 140° C., reacts with an amine (B) at 0 to 140° C. to form the urea-modified polyester (UMPE).

The toner includes the first binder resin other than the second binder resin, as described above. Preferably, the first binder resin comprises an unmodified polyester (PE) which provides the toner with low-temperature fixability and proper gloss property. The unmodified polyester (PE) may be a polycondensation product of the above-described polyol (PO) and the above-described polycarboxylic acid (PC), for example. The unmodified polyester (PE) preferably has a weight average molecular weight (Mw) of from 10,000 to 300,000, and more preferably from 14,000 to 200,000. Also, the unmodified polyester (PE) preferably has a number average molecular weight (Mn) of from 1,000 to 10,000, and more preferably from 1,500 to 6,000.

Preferably, the urea-modified polyester (UMPE) and the unmodified polyester (PE) are compatible with each other from the viewpoint of improving low-temperature fixability and high-temperature offset resistance of the resultant toner. Accordingly, it is preferable that the chemical compositions of UMPE and PE are similar. In the toner, the weight ratio of UMPE to PE is preferably 5/95 to 80/20, more preferably from 5/95 to 30/70, much more preferably from 5/95 to 25/75, and most preferably from 7/93 to 20/80. When the weight ratio of UMPE is too small, high-temperature offset resistance, heat-resistant storage stability, and low-temperature fixability of the resulting toner may be poor. The unmodified polyester (PE) preferably has a hydroxyl value (mgKOH/g) of 5 or more. Also, the unmodified polyester (PE) preferably has an acid value (mgKOH/g) of from 1.0 to 50.0. Within such an acid value range of PE, the resulting toner is easily chargeable negatively, has good affinity for paper and low-temperature fixability. When the acid value of PE is too high, the polymer reactive with the hydrogen group may not satisfactorily elongate or cross-link, resulting in poor high-temperature offset resistance. Moreover, the resulting toner may be environmentally unstable in charge. When the acid value is too low, the polymer reactive with the hydrogen group may elongate or cross-link too much, resulting in unstable manufacture stability. When the acid value is not constant, the emulsification process (i.e., granulation process) may become unstable.

Also, the acid value of a toner generally indicates low-temperature fixability and high-temperature offset resistance. In the toner according to this specification, the acid value depends on terminal carboxyl groups in the unmodified polyester (PE). The toner according to this specification preferably has an acid value of from 0.5 to 40.0 mgKOH/g.

The hydroxyl value and the acid value can be measured under the following conditions.

Measuring instrument: Potentiometric titrator DL-53 (from Mettler-Toledo International Inc.)

Electrode: DG113-SC (from Mettler-Toledo International Inc.)

Analysis software: LabX Light Version 1.00.000

Calibration of the instrument: using a mixture solvent of 120 ml of toluene and 30 ml of ethanol

Measuring temperature: 23° C.

More detailed measuring conditions are set as follows.

Stir

| | |
|---|---|
| Speed [%] | 25 |
| Time [S] | 15 |

EQP titration
Titrant/Sensor

| Titrant | CH3ONa |
|---|---|
| Concentration [mol/l] | 0.1 |
| Sensor | DG115 |
| Unit of measurement | mV |
| Predispensing | To volume |
| Volume [mL) | 1.0 |
| Wait time [s] | 0 |
| Titrant addition | Dynamic |
| dE(set) [mV] | 8.0 |
| dE(min) [mL] | 0.03 |
| dV(max) [mL] | 0.5 |
| | Equilibrium |
| Measure mode | controlled |
| dE [mV] | 0.5 |
| dt [s] | 1.0 |
| T(min) [S] | 2.0 |
| T(max) [S] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | yes |
| n = 1 | |
| comb. termination conditions | No |

Evaluation

| Procedure | Standard |
|---|---|
| Potential 1 | No |
| Potential 2 | No |
| Stop for reevaluation | No |

The acid value can be measured based on a method according to JIS K0070-1992. First, 0.5 g of a sample is dissolved in 120 ml of toluene by agitating at 23° C. for about 10 hours. Further, 30 ml of ethanol are added thereto, thus preparing a sample liquid.

The sample liquid is subjected to a measurement using the above-described instrument. Specifically, the sample liquid is titrated with an N/10 alcohol solution of potassium hydroxide and the acid value (AV) is calculated from the following equation:

AV=M (ml)×N×56.1/W

wherein M represents a consumption of the N/10 alcohol solution of potassium hydroxide in the titration, N represents the factor of the N/10 alcohol solution of potassium hydroxide, and W represents the weight of the sample liquid.

The hydroxyl value can be measured based on a method according to JIS K0070-1966. First, 0.5 g of a sample are precisely weighed and contained in a 100-ml measuring flask, and then 5 ml of an acetylation agent are added thereto. The flask is immersed in a bath at 100° C.±5° C. for 1 to 2 hours, followed by cooling out of the bath. After adding water to the flask, the flask is shaken to decompose acetic anhydride. To complete decomposition of acetic anhydride, the flask is re-immersed in the flask and reheated for 10 minutes or more, followed by cooling out of the bath. Thereafter, the inner wall of the flask is washed with an organic solvent. The sample liquid in the flask is subjected to a potentiometric titration with the above-described electrode and an N/2 ethyl alcohol solution of potassium hydroxide.

Preferably, the first binder resin comprises an unmodified polyester (PE) in an amount of from 50 to 100% by weight. When the amount of PE is too small, low-temperature fixability of the resultant toner may be poor.

To provide the toner with better low-temperature fixability and high-temperature offset resistance while maintaining heat-resistant storage stability, the unmodified polyester resin (PE) preferably includes THF-soluble components having a weight average molecular weight (Mw) of from 1,000 to 30,000. When Mw of the THF-soluble components is too small, it means that the THF-soluble components include too large an amount of oligomers, which results in poor heat-resistant storage stability. When Mw of the THF-soluble components is too large, the prepolymer may not satisfactorily react, which results in poor high-temperature offset resistance.

Molecular weight of the unmodified polyester resin (PE) can be measured by GPC (gel permeation chromatography) as follows. In a GPC instrument, columns are heated to 40° C. and THF (tetrahydrofuran) is flown therein at a rate of 1 ml/min. Then 50 to 200 μl of a THF solution containing 0.05 to 0.6% by weight of a sample is injected in the instrument to measure a molecular weight distribution of the sample. The molecular weight distribution is determined from a calibration curve created from several kinds of monodisperse polystyrene standard samples, which correlates the logarithm of molecular weight to the number of counts of a detector (e.g., a refractive index detector). Preferably, the number of the polystyrene standard samples is at least 10, with each having a molecular weight of 6×10², 2.1×10³, 4×10³, 1.75×10⁴, 5.1×10⁴, 1.1×10⁵, 3.9×10⁵, 8.6×10⁵, 2×10⁶, and 4.48×10⁶, for example. Such polystyrene standard samples are available from Pressure Chemical Company or Tosoh Corporation.

The toner preferably has a glass transition temperature (Tg) of from 40 to 70° C., and more preferably from 40 to 60° C. When Tg is too low, it means that heat resistance of the toner is poor. When Tg is too high, it means that low-temperature fixability of the toner is poor. Because of including the second binder resin such as a urea-modified polyester resin along with the first binder resin, the toner according to this specification has better heat-resistant storage stability even though Tg is lower compared to typical polyester-based toners.

The unmodified polyester resin (PE) preferably has a glass transition temperature (Tg) of from 35 to 65° C. When Tg of PE is too low, heat-resistant storage stability of the resulting toner may be poor. When Tg of PE is too high, low-temperature fixability of the resulting toner may be poor.

The glass transition temperature (Tg) can be measured using an instrument such as THERMOFLEX TG8110 and TAS-100 (both from Rigaku Corporation) as follows.

First, an aluminum container is charged with approximately 10 mg of a sample. The container is put on a holder unit and set in an electric furnace. The sample is subjected to a DSC (differential scanning calorimetry) measurement by being heated from room temperature to 150° C. at a heating rate of 10° C./min, left at 150° C. for 10 minutes, cooled to room temperature again, left at room temperature for 10 minutes, and reheated to 150° C. at a heating rate of 10° C./min in nitrogen atmosphere. Tg is determined from an intersection point of a contact line of an endothermic curve with a base line.

As described above, the toner according to this specification includes the first and second binder resins, a release agent, and a colorant. The toner may optionally include other materials such as a charge controlling agent and an external additive.

As the release agent, a wax having a low melting point of from 50 to 120° C. is suitable. Such a wax can effectively release the toner from a fixing member without applying oil to the fixing member. In the present specification, the melting point of a wax is defined as a maximum endothermic peak observed in a DSC (differential scanning calorimetry) measurement.

Specific examples of suitable release agents include, but are not limited to, natural waxes such as plant waxes (e.g., carnauba wax, cotton wax, sumac wax, rice wax), animal waxes (e.g., bees wax, lanoline), mineral waxes (e.g., ozokerite, ceresin), and petroleum waxes (e.g., paraffin, micro-crystalline wax, petrolatum); synthetic hydrocarbon waxes (e.g., Fischer-Tropsch wax, polyethylene wax); synthetic waxes (e.g., ester, ketone, ether); fatty acid amides (e.g., 12-hydroxysteraric acid amide, stearic acid amide, phthalic anhydride imide, chlorinated hydrocarbon); low-molecular-weight crystalline polymers (e.g., homopolymer of a polyacrylate such as poly(n-stearyl methacrylate) and poly(n-lauryl methacrylate) and copolymer of polyacrylates such as n-stearyl acrylate-ethyl methacrylate copolymer); and low-molecular-weight crystalline polymers having a long alkyl side chain. The toner preferably includes the release agent in an amount of from 0 to 40% by weight, more preferably from 3 to 30% by weight, based on the total weight of the first and second binder resins.

Specific examples of usable colorants include, but are not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red FSR, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, etc. These materials can be used alone or in combination. The toner preferably includes the colorant in an amount of from 1 to 15% by weight, and more preferably from 3 to 10% by weight.

The colorant can be combined with a resin to be used as a master batch. Specific examples of usable resin for the master batch include, but are not limited to, the above-described modified or unmodified polyester resins, styrene polymers and substituted styrene polymers (e.g., polystyrene, poly-p-chlorostyrene, polyvinyltoluene), styrene copolymers (e.g., styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl a-chloro methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleic acid ester copolymer), polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid, rosin, modified rosin, terpene resin, aliphatic or alicyclic hydrocarbon resin, aromatic petroleum resin, chlorinated paraffin, and paraffin wax. These resins can be used alone or in combination.

The master batches can be prepared by mixing one or more of the resins as mentioned above and the colorant as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed, can be preferably used because the resultant wet cake can be used as it is without being dried. When performing the mixing and kneading process, dispersing devices capable of applying a high shearing force such as three roll mills can be preferably used.

Specific examples of usable charge controlling agent include, but are not limited to, Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, and salicylic acid derivatives, but are not limited thereto.

Specific examples of commercially available charge controlling agents include, but are not limited to, BONTRON® N-03 (Nigrosine dyes), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, and azo pigments and polymers having a functional group such as a sulfonate group, a carboxyl group, and a quaternary ammonium group.

The content of the charge controlling agent is determined depending on the species of the binder resin used, and toner manufacturing method used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large a charge quantity. Such a highly-charged toner may increase electrostatic attracting force between a developing roller and the toner, degrading fluidity of the toner and image density.

A charge controlling agent may be fixed on the surface of the toner by mixing them in a vessel without any convexity on the inner wall with a rotator rotating at a revolution of from 40 to 150 m/sec, for example.

To provide the toner with better fluidity, developability, and chargeability, particulate inorganic materials may be externally added to the toner. A suitable particulate inorganic material preferably has a primary particle diameter of from 5 mμ to 2 μm, and more preferably from 5 mμ to 500 μm, and preferably has a BET specific surface area of from 20 to 500 m²/g. The toner preferably includes the particulate inorganic material in an amount of from 0.01 to 5% by weight, and more preferably from 0.01 to 2.0% by weight.

Specific examples of usable particulate inorganic materials include, but are not limited to silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. These particulate inorganic materials can be used alone or in combination with each other. In particular, a combination of a hydrophobized silica and a hydrophobized titanium oxide is preferable. More preferably, both hydrophobized silica and hydrophobized titanium oxide have an average particle diameter of 5 mμ or less. In such a case, the electrostatic force and van der Waals force between the particulate materials and the toner drastically improve. Therefore, the particulate materials will unlikely release from the toner even when the toner receives mechanical stress in a developing device, providing high quality images with high transfer performance.

When the toner includes a hydrophobized silica and a hydrophobized titanium oxide each in an amount of from 0.3 to 1.5% by weight, the toner can be quickly charged.

Another exemplary aspect of the present invention also provides a method of manufacturing the above-described toner. The method includes dissolving or dispersing the first binder resin, the compound having an active hydrogen group, the polymer reactive with the active hydrogen group, the colorant, and the release agent in an organic solvent to prepare a toner components liquid; dispersing the toner components liquid in an aqueous medium containing a particulate resin to prepare oil droplets, while reacting the compound having an active hydrogen group with the polymer reactive with the active hydrogen group to form the second binder resin; removing the organic solvent from the oil droplets to prepare toner particles; and washing and drying the toner particles.

The aqueous medium may be water or a mixture of water and a water-miscible solvent, for example. Specific examples of usable water-miscible solvents include, but are not limited to, alcohols (e.g., methanol, isopropanol, ethylene glycol), dimethylformamide, tetrahydrofuran, cellosolves (e.g., methyl cellosolve), and lower ketones (e.g., acetone, methyl ethyl ketone).

Preferably, the compound having an active hydrogen group is an amine (B) and the polymer reactive with the active hydrogen group is a polyester prepolymer (A) having an isocyanate group. In this case, a urea-modified polyester resin (UMPE) is formed in the aqueous medium. Raw materials of the toner including the polyester prepolymer (A), a colorant or a master batch, a release agent, a charge controlling agent, an unmodified polyester, etc., are mixed in advance, and the resulting mixture (hereinafter “toner components liquid”) is dispersed in the aqueous medium while applying shearing force thereto. Alternatively, the charge controlling agent may be fixed to the surface of the resulting toner particles. Therefore, the charge controlling agent needs not necessarily be included in the toner components liquid.

The toner components liquid further includes an organic solvent. Organic solvents having a boiling point of less than 100° C. are preferable because such solvents are easily removable.

Specific examples of usable organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, and mixtures thereof. In particular, aromatic solvents such as toluene and xylene and halogenated hydrocarbons such as methylene chloride, 1,2-dichloroethane, chloroform, and carbon tetrachloride are preferable. The toner components liquid preferably includes the organic solvent in an amount of from 25 to 70 parts by weight, based on 100 parts by weight of the toner components liquid. The solvent is removed from the oil droplets after the termination of the reaction between the polyester prepolymer (A) and the amine (B) under normal or reduced pressures.

Suitable dispersers for dispersing the toner components liquid in the aqueous medium include a low-speed-shearing disperser, a high-speed-shearing disperser, a frictional disperser, a high-pressure jet disperser, and an ultrasonic disperser. A high-speed-shearing disperser is preferable so as to control the particle diameter of the dispersing oil droplets into 2 to 20 μm. In this case, the revolution of the high-speed-shearing disperser is preferably from 1,000 to 30,000 rpm, and more preferably from 5,000 to 20,000 rpm. The dispersing time is preferably from 0.1 to 5 minutes. The dispersing temperature is preferably from 0 to 150° C. (under pressure), and more preferably from 40 to 98° C. The higher the temperature, the lower the viscosity of the toner components liquid, which is easier to disperse the toner components liquid in the aqueous medium.

The amount of the aqueous medium is preferably 50 to 2,000 parts by weight, and more preferably from 100 to 1,000 parts by weight, based on 100 parts by weight of the toner components liquid. When the amount is too small, the toner components liquid may not be reliably dispersed and the resulting toner particles may have an undesired size. When the amount is too large, the toner manufacturing cost may increase.

The aqueous medium contains a dispersing agent such as a surfactant, an inorganic dispersing agent, and a particulate polymer dispersing agent.

Specific examples of usable surfactants include, but are not limited to, anionic surfactants (e.g., alkylbenzene sulfonates, a-olefin sulfonates, phosphates), cationic surfactants (e.g., amine salt types such as alkylamine salts, amino alcohol fatty acid derivatives, polyamine fatty acid derivatives, and imidazolines; quaternary ammonium salt types such as alkyl trimethyl ammonium salts, dialkyl dimethyl ammonium salts, alkyl dimethyl benzyl ammonium salts, pyridinium salts, alkyl isoquinolinium salts, and benzethonium chlorides), nonionic surfactants (e.g., fatty acid amide derivatives, polyvalent alcohol derivatives), and amphoteric surfactants (e.g., alanine, dodecyl di(aminoethyl) glycine, di(octyl aminoethyl) glycine, N-alkyl-N,N-dimethyl ammonium betaine).

Surfactants having a fluoroalkyl group are also usable. Specific examples of anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[ω-fluoroalkyl(C6-C11)oxy]-1-alkyl(C3-C4) sulfonic acid sodium, 3-[ω-fluoroalkanoyl(C6-C8)-N-ethylamino]-1-propane sulfonic acid sodium, fluoroalkyl(C11-C20) carboxylic acids and metal salts thereof, perfluoroalkyl(C7-C13) carboxylic acids and metal salts thereof, perfluoroalkyl(C4-C12) sulfonic acids and metal salts thereof, perfluorooctane sulfonic acid dimethanol amide, N-propyl-N-(2-hydroxyethyl) perfluorooctane sulfonamide, perfluoroalkyl(C6-C10) sulfonamide propyl trimethyl ammonium salts, perfluoroalkyl(C6-C10)-N-ethyl sulfonyl glycine salts, and monoperfluoroalkyl(C6-C16) ethyl phosphates.

Specific examples of commercially available anionic surfactants having a fluoroalkyl group include, but are not limited to, SARFRON® S-111, S-112 and S-113 (manufactured by Asahi Glass Co., Ltd.); FLUORAD® FC-93, FC-95, FC-98 and FC-129 (manufactured by Sumitomo 3M Ltd.); UNIDYNE® DS-101 and DS-102 (manufactured by Daikin Industries, Ltd.); MEGAFACE® F-110, F-120, F-113, F-191, F-812 and F-833 (manufactured by Dainippon Ink and Chemicals, Inc.); ECTOP® EF-102, 103, 104, 105, 112, 123A, 123B, 306A, 501, 201 and 204 (manufactured by Tochem Products Co., Ltd.); and FUTARGENT® F-100 and F-150 (manufactured by Neos).

Specific examples of cationic surfactants having a fluoroalkyl group include, but are not limited to, aliphatic primary, secondary, and tertiary amine acids having a fluoroalkyl group; and aliphatic tertiary ammonium salts such as perfluoroalkyl(C6-C10) sulfonamide propyl trimethyl ammonium salts, benzalkonium salts, benzethonium chlorides, pyridinium salts, and imidazolinium salts.

Specific examples of commercially available cationic surfactants include, but are not limited to, SARFRON® S-121 (manufactured by Asahi Glass Co., Ltd.); FLUORAD® FC-135 (manufactured by Sumitomo 3M Ltd.); UNIDYNE® DS-202 (manufactured by Daikin Industries, Ltd.); MEGAFACE® F-150 and F-824 (manufactured by Dainippon Ink and Chemicals, Inc.); ECTOP® EF-132 (manufactured by Tohchem Products Co., Ltd.); and FUTARGENT® F-300 (manufactured by Neos).

Specific examples of usable inorganic dispersing agents include, but are not limited to, tricalcium phosphate, calcium carbonate, titanium oxide, colloidal silica, and hydroxyapatite, all of which have poor solubility in water.

Specific examples of usable particulate polymer dispersing agents include, but are not limited to, particulate MMA polymers having a particle diameter of 1 μm or 3 μm, particulate styrene polymers having a particle diameter of 0.5 μm or 2 μm, and particulate styrene-acrylonitrile polymers having a particle diameter of 1 μm. Specific examples of commercially available particulate polymer dispersing agents include, but are not limited to, PB-200H (from Kao Corporation), SGP and SCP-3G (from Souken), TECHPOLYMER SB (from Sekisui Plastics Co., Ltd.), and MICROPEARL (from Sekisui Chemical Co., Ltd.).

Additionally, polymeric protection colloids are usable in combination with the above inorganic dispersing agents and particulate polymer dispersing agents so as to improve stability of the dispersing oil droplets.

Specific examples of usable polymeric protection colloids include, but are not limited to, homopolymers and copolymers obtained from monomers having carboxyl group, alkyl(meth)acrylates having hydroxyl group, vinyl ethers, vinyl carboxylates, amide monomers, acid chloride monomers, and/or monomers containing nitrogen or a heterocyclic ring containing nitrogen; polyoxyethylene-based resins; and celluloses. The above homopolymers and copolymers may include a unit derived from vinyl alcohols.

Specific examples of usable monomers having carboxyl group include, but are not limited to, acrylic acid, methacrylic acid, α-cyanoacrylic acid, α-cyanomethacrylic acid, itaconic acid, crotonic acid, fumaric acid, maleic acid, and maleic anhydride.

Specific examples of usable alkyl(meth)acrylates having hydroxyl group include, but are not limited to, β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, and glycerin monomethacrylate.

Specific examples of usable vinyl ethers include, but are not limited to, vinyl methyl ether, vinyl ethyl ether, and vinyl propyl ether.

Specific examples of usable vinyl carboxylates include, but are not limited to, vinyl acetate, vinyl propionate, and vinyl butyrate.

Specific examples of usable amide monomers include, but are not limited to, acrylamide, methacrylamide, diacetone acrylamide, N-methylol acrylamide, and N-methylol methacrylamide.

Specific examples of usable acid chloride monomers include, but are not limited to, acrylic acid chloride and methacrylic acid chloride.

Specific examples of usable monomers containing nitrogen or a heterocyclic ring containing nitrogen include, but are not limited to, vinyl pyridine, vinyl pyrrolidone, vinyl imidazole, and ethylene imine.

Specific examples of usable polyoxyethylene-based resins include, but are not limited to, polyoxyethylene, polyoxypropylene, polyoxyethylene alkyl amine, polyoxypropylene alkyl amine, polyoxyethylene alkyl amide, polyoxypropylene alkyl amide, polyoxyethylene nonylphenyl ether, polyoxyethylene laurylphenyl ether, polyoxyethylene phenyl stearate, and polyoxyethylene phenyl pelargonate.

Specific examples of usable celluloses include, but are not limited to, methyl cellulose, hydroxyethyl cellulose, and hydroxypropyl cellulose.

The elongation and/or cross-linking time between the polyester prepolymer (A) having an isocyanate group and the amine (B) is preferably from 10 minutes to 40 hours, and more preferably from 2 to 24 hours. The reacting temperature is preferably from 0 to 150° C., and more preferably from 40 to 98° C. A catalyst (e.g., dibutyltin laurate, dioctyltin laurate) may ne used, if needed.

The toner preferably has a volume average particle diameter (Dv) of from 3 to 7 μm. Generally, as the particle diameter becomes smaller, the image quality becomes higher but the transferability and cleanability become lower. When Dv is below the above-described range and the toner is used for a two-component developer, the toner particles may adhere to carrier particles along with repeated mixing operation in a developing device, thereby degrading charging ability of the carrier particles. When Dv is below the above-described range and the toner is used for a one-component developer, the toner particles may adhere to a developing roller and/or a toner layer forming blade. When Dv is above the above-described range, the resultant image resolution and quality may be poor, and the average particular diameter of toner particles in a two-component developer may vary along with repeated consumption and supplement of toner particles.

Further, when the toner includes fine toner particles having a particle diameter of 2 μm or less in an amount of 10% by number or more, the toner is more likely to adhere to carrier particles.

To produce higher resolution and higher quality images, the ratio (Dv/Dn) of the volume average particle diameter (Dv) to the number average particle diameter (Dn) of the toner is preferably 1.20 or less, and more preferably from 1.00 to 1.20. Within such a range, the average particular diameter of toner particles in a two-component developer may not vary along with repeated consumption and supplement of toner particles, providing reliable developability for an extended period of time. When Dv/Dn is too large, it means that the particle size distribution is too wide, degrading micro-dot reproducibility.

The average particle diameter and particle diameter distribution of the toner can be measured using a measuring instrument such as COULTER COUNTER TA-II and COULTER MULTISIZER II (both from Beckman Coulter K.K.). The measuring instrument is connected to an interface (from The Institute of JUSE) that outputs number distribution and volume distribution and a personal computer PC9801 (from NEC Corporation).

A measuring procedure is as follows. First, 0.1 to 5 ml of a surfactant (preferably alkylbenzene sulfonate) is added to 100 to 150 ml of an electrolyte (i.e., a 1% NaCl aqueous solution including a first grade sodium chloride, such as ISOTON-II from Coulter Electrons Inc.). Thereafter, 2 to 20 mg of the toner is added to the electrolyte and subjected to a dispersing treatment with an ultrasonic disperser for about 1 to 3 minutes to prepare a suspension liquid. The suspension liquid is then subjected to a measurement of the volume and number distributions of toner particles using the measuring instrument equipped with a 100-μm aperture.

The channels include 13 channels as follows: from 2.00 to less than 2.52 μm; from 2.52 to less than 3.17 μm; from 3.17 to less than 4.00 μm; from 4.00 to less than 5.04 μm; from 5.04 to less than 6.35 μm; from 6.35 to less than 8.00 μm; from 8.00 to less than 10.08 μm; from 10.08 to less than 12.70 μm; from 12.70 to less than 16.00 μm; from 16.00 to less than 20.20 μm; from 20.20 to less than 25.40 μm; from 25.40 to less than 32.00 μm; and from 32.00 to less than 40.30 μm. Accordingly, particles having a particle diameter of from 2.00 μm to less than 40.30 μm can be measured.

The volume average particle diameter (Dv) and the number average particle diameter (Dn) are calculated from the measured volume distribution and number distribution, respectively.

The number of toner particles having a particle diameter of 2 μm or less can be measured using a particle size analyzer FPIA-2100 (from Sysmex Corporation) and an analysis software program “FPIA-2100 Data Processing Program for FPIA version 00-10”. A measuring procedure is as follows. First, 0.1 to 0.5 ml of a 10% surfactant (an alkylbenzene sulfonate, NEOGEN SC-A from Dai-ichi Kogyo Seiyaku Co., Ltd.) are contained in a 100-ml beaker, and 0.1 to 0.5 g of the toner are added thereto. After mixing the toner with a micro-spatula, 80 ml of ion-exchange water are further added to the beaker and subjected to a dispersion treatment for 3 minutes using an ultrasonic disperser (from Honda Electronics) to prepare a dispersion liquid. The dispersion liquid is subjected to a measurement of the shape and size of toner particles with FPIA-2100 until the number of the measured toner particles becomes 5,000 to 15,000 per micro-liter.

The toner according to this specification may be used for a two-component developer. The two-component developer preferably includes the toner in an amount of from 1 to 10 parts by weight and a magnetic carrier in an amount of 100 parts by weight.

The magnetic carrier may be powders of iron, ferrite, or magnetite, or magnetic resin particles, having a particle diameter of from 20 to 200 μm. The surface of magnetic carrier is preferably covered with a covering material such as amino-based resins (e.g., urea-formaldehyde resin, melamine resin, benzoguanamine resin, urea resin, polyamide resin, epoxy resin), polyvinyl- and polyvinylidene-based resins (e.g., acrylic resin, polymethyl methacrylate resin, polyacrylonitrile resin, polyvinyl acetate resin, polyvinyl alcohol resin, polyvinyl butyral resin), polystyrene-based resins (e.g., polystyrene resin, styrene-acrylic copolymer resin), halogenated olefin resins (e.g., polyvinyl chloride), polyester-based resins (e.g., polyethylene terephthalate resin, polybutylene terephthalate resin), polycarbonate-based resins, polyethylene resins, polyvinyl fluoride resins, polyvinylidene fluoride resins, polytrifluoroethylene resins, polyhexafluoropropylene resins, vinylidene fluoride-acrylate copolymers, vinylidene fluoride-vinyl fluoride copolymers, tetrafluoroethylene-vinylidene fluoride-non-fluoromonomer terpolymers, and silicone resins.

The covering material may include a conductive powder therein. The conductive powder may be a metal powder, carbon black, titanium oxide, tin oxide, or zinc oxide, for example. The conductive powder preferably has an average particle diameter of 1 μm or less. When the average particle diameter is too large, it is difficult to control electric resistance.

The toner according to this specification may also be used for a one-component developer including no magnetic carrier.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Examples

### Preparation of Particulate Resin Dispersion

A reaction vessel equipped with a stirrer and a thermometer was charged with 683 parts of water, 11 parts of a sodium salt of sulfate ester of ethylene oxide adduct of methacrylic acid (ELEMINOL RS-30 from Sanyo Chemical Industries, Ltd.), 83 parts of styrene, 83 parts of methacrylic acid, 110 parts of butyl acrylate, and 1 part of ammonium persulfate. The mixture was agitated at a revolution of 400 rpm for 15 minutes. Thus, a whitish emulsion was prepared.

The whitish emulsion was heated to 75° C. and subjected to a reaction for 5 hours. Further, 30 parts of a 1% aqueous solution of ammonium persulfate were added thereto, and the mixture was aged at 75° C. for 5 hours. Thus, a particulate resin dispersion 1 (i.e., an aqueous dispersion of a copolymer of styrene, methacrylic acid, butyl acrylate, and sodium salt of sulfate ester of ethylene oxide adduct of methacrylic acid) was prepared.

As a result of a measurement using a particle size distribution analyzer LA-920 (from Horiba, Ltd.), the particulate resin dispersion 1 was containing resin particles having a volume average particle diameter of 105 nm. A part of the particulate resin dispersion 1 was dried to separate a part of the resin particles. The resin particles had a glass transition temperature (Tg) of 59° C. and a weight average molecular weight of 150,000.

### Preparation of Low-Molecular-Weight Polyester

A reaction vessel equipped with a condenser, a stirrer, and a nitrogen inlet pipe was charged with 229 parts of ethylene oxide 2 mol adduct of bisphenol A, 529 parts of propylene oxide 3 mol adduct of bisphenol A, 208 parts of terephthalic acid, 46 parts of isophthalic acid, and 2 parts of dibutyltin oxide. The mixture was subjected to a reaction under normal pressures at 230° C. for 5 hours, and subsequently under reduced pressures of from 10 to 15 mmHg for 5 hours. Further, 44 parts of trimellitic anhydride were added thereto, and the mixture was subjected to a reaction under normal pressures at 180° C. for 2 hours. Thus, a low-molecular-weight polyester 1 was prepared. The low-molecular-weight polyester 1 included THF-soluble components having a weight average molecular weight (Mw) of 5,200, a glass transition temperature (Tg) of 45° C., and an acid value of 20 mgKOH/g.

### Preparation of Prepolymer

A reaction vessel equipped with a condenser, a stirrer, and a nitrogen inlet pipe was charged with 795 parts of ethylene oxide 2 mol adduct of bisphenol A, 200 parts of isophthalic acid, 65 parts of terephthalic acid, and 2 parts of dibutyltin oxide. The mixture was subjected to a condensation reaction under normal pressures and nitrogen gas flow at 210° C. for 8 hours, and subsequently under reduced pressures of from 10 to 15 mmHg for 5 hours while removing the produced water. After being cooled to 80° C., the resulting product was subjected to a reaction with 170 parts of isophorone diisocyanate in ethyl acetate for 2 hours. Thus, a prepolymer solution 1 containing a prepolymer was prepared. The prepolymer had a weight average molecular weight of 90,000. The prepolymer solution 1 included the prepolymer in an amount of 50% by weight.

### Preparation of Toner Components Liquid 1

A beaker was charged with 20 parts of the prepolymer solution 1 containing 10 parts of the prepolymer, 55 parts of the low-molecular-weight polyester 1, and 80 parts of ethyl acetate, and the mixture was agitated. A bead mill was filled with 15 parts of a carnauba wax, 20 parts of a carbon black, and 110 parts of ethyl acetate, and the mixture was subjected to a dispersion treatment for 30 minutes. The above-prepared two liquids were mixed using a TK HOMOMIXER at a revolution of 12,000 rpm for 5 minutes, followed by a dispersion treatment using a bead mill for 10 minutes. Further, 2.9 parts of isophorone diamine were added, and the mixture was agitated using a TK HOMOMIXER at a revolution of 12,000 rpm for 5 minutes. Thus, a toner components liquid 1 was prepared.

### Preparation of Toner Components Liquid 2

A beaker was charged with 72 parts of the prepolymer solution 1 containing 36 parts of the prepolymer, 129 parts of the low-molecular-weight polyester 1, and 80 parts of ethyl acetate, and the mixture was agitated. A bead mill was filled with 15 parts of a carnauba wax, 20 parts of a carbon black, and 84 parts of ethyl acetate, and the mixture was subjected to a dispersion treatment for 30 minutes. The above-prepared two liquids were mixed using a TK HOMOMIXER at a revolution of 12,000 rpm for 5 minutes, followed by a dispersion treatment using a bead mill for 10 minutes. Further, 2.9 parts of isophorone diamine were added, and the mixture was agitated using a TK HOMOMIXER at a revolution of 12,000 rpm for 5 minutes. Thus, a toner components liquid 2 was prepared.

### Preparation of Toner Components Liquid 3

A beaker was charged with 160 parts of the prepolymer solution 1 containing 80 parts of the prepolymer, 85 parts of the low-molecular-weight polyester 1, and 80 parts of ethyl acetate, and the mixture was agitated. A bead mill was filled with 15 parts of a carnauba wax, 20 parts of a carbon black, and 40 parts of ethyl acetate, and the mixture was subjected to a dispersion treatment for 30 minutes. The above-prepared two liquids were mixed using a TK HOMOMIXER at a revolution of 12,000 rpm for 5 minutes, followed by a dispersion treatment using a bead mill for 10 minutes. Further, 2.9 parts of isophorone diamine were added, and the mixture was agitated using a TK HOMOMIXER at a revolution of 12,000 rpm for 5 minutes. Thus, a toner components liquid 3 was prepared.

### Preparation of Toner Components Liquid 4

A beaker was charged with 16 parts of the prepolymer solution 1 containing 8 parts of the prepolymer, 157 parts of the low-molecular-weight polyester 1, and 80 parts of ethyl acetate, and the mixture was agitated. A bead mill was filled with 15 parts of a carnauba wax, 20 parts of a carbon black, and 112 parts of ethyl acetate, and the mixture was subjected to a dispersion treatment for 30 minutes. The above-prepared two liquids were mixed using a TK HOMOMIXER at a revolution of 12,000 rpm for 5 minutes, followed by a dispersion treatment using a bead mill for 10 minutes. Further, 2.9 parts of isophorone diamine were added, and the mixture was agitated using a TK HOMOMIXER at a revolution of 12,000 rpm for 5 minutes. Thus, a toner components liquid 4 was prepared.

### Preparation of Toner Components Liquid 5

A beaker was charged with 80 parts of the prepolymer solution 1 containing 40 parts of the prepolymer, 125 parts of the low-molecular-weight polyester 1, and 80 parts of ethyl acetate, and the mixture was agitated. A bead mill was filled with 15 parts of a carnauba wax, 20 parts of a carbon black, and 84 parts of ethyl acetate, and the mixture was subjected to a dispersion treatment for 30 minutes. The above-prepared two liquids were mixed using a TK HOMOMIXER at a revolution of 12,000 rpm for 5 minutes, followed by a dispersion treatment using a bead mill for 10 minutes. Further, 2.9 parts of isophorone diamine were added, and the mixture was agitated using a TK HOMOMIXER at a revolution of 12,000 rpm for 5 minutes. Thus, a toner components liquid 5 was prepared.

### Preparation of Toner Components Liquid 6

A beaker was charged with 160 parts of the prepolymer solution 1 containing 80 parts of the prepolymer, 85 parts of the low-molecular-weight polyester 1, and 80 parts of ethyl acetate, and the mixture was agitated. A bead mill was filled with 15 parts of a carnauba wax, 20 parts of a carbon black, and 40 parts of ethyl acetate, and the mixture was subjected to a dispersion treatment for 30 minutes. The above-prepared two liquids were mixed using a TK HOMOMIXER at a revolution of 12,000 rpm for 5 minutes, followed by a dispersion treatment using a bead mill for 10 minutes. Further, 2.9 parts of isophorone diamine were added, and the mixture was agitated using a TK HOMOMIXER at a revolution of 12,000 rpm for 5 minutes. Thus, a toner components liquid 6 was prepared.

### Preparation of Toner Components Liquid 7

A beaker was charged with 200 parts of the prepolymer solution 1 containing 100 parts of the prepolymer, 65 parts of the low-molecular-weight polyester 1, and 80 parts of ethyl acetate, and the mixture was agitated. A bead mill was filled with 15 parts of a carnauba wax, 20 parts of a carbon black, and 20 parts of ethyl acetate, and the mixture was subjected to a dispersion treatment for 30 minutes. The above-prepared two liquids were mixed using a TK HOMOMIXER at a revolution of 12,000 rpm for 5 minutes, followed by a dispersion treatment using a bead mill for 10 minutes. Further, 2.9 parts of isophorone diamine were added, and the mixture was agitated using a TK HOMOMIXER at a revolution of 12,000 rpm for 5 minutes. Thus, a toner components liquid 7 was prepared.

### Example 1

To prepare an aqueous medium, 529.5 parts of ion-exchange water, 70 parts of the particulate resin dispersion 1, and 0.5 parts of sodium dodecylbenzenesulfonate were contained in a beaker and agitated using a TK HOMOMIXER at a revolution of 12,000 rpm. The resulting aqueous medium was mixed with 405.1 parts of the toner components liquid 1 for 30 minutes to prepare a dispersion slurry. The ethyl acetate in the dispersion slurry was removed until that the concentration fell below 0.9%.

The dispersion slurry was then aged for 10 hours at 50° C., and subjected to filtering, washing, drying, and classification using wind power. Thus, a mother toner was prepared.

Next, 100 parts of the mother toner and 0.25 parts of a charge controlling agent (BONTRON E-84 from Orient Chemical Industries Co., Ltd.) were mixed using a Q-type mixer (from Mitsui Mining Co., Ltd.) with setting the revolution of turbine blades to 50 m/sec. This mixing operation was performed for 2 minutes, followed by a pause for 1 minute. This cycle was repeated for 5 times, which resulted in the total mixing time of 10 minutes. Further, 0.5 parts of a hydrophobized silica (H2000 from Clariant Japan K.K.) were mixed therein with setting the revolution to 15 m/sec. This mixing operation was performed for 30 minutes, followed by a pause for 1 minute. This cycle was repeated for 5 times. Thus, a toner 1 was prepared.

### Example 2

The procedure for preparing the toner 1 in Example 1 was repeated except for changing the aging time to 15 hours. Thus, a toner 2 was prepared.

### Example 3

The procedure for preparing the toner 1 in Example 1 was repeated except for changing the aging temperature and time to 60° C. and 15 hours, respectively. Thus, a toner 3 was prepared.

### Example 4

To prepare an aqueous medium, 529.5 parts of ion-exchange water, 70 parts of the particulate resin dispersion 1, and 0.5 parts of sodium dodecylbenzenesulfonate were contained in a beaker and agitated using a TK HOMOMIXER at a revolution of 12,000 rpm. The resulting aqueous medium was mixed with 405.1 parts of the toner components liquid 2 for 30 minutes to prepare a dispersion slurry. The ethyl acetate in the dispersion slurry was removed until that the concentration fell below 0.9%.

The dispersion slurry was then aged for 5 hours at 50° C., and subjected to filtering, washing, drying, and classification using wind power. Thus, a mother toner was prepared.

Next, 100 parts of the mother toner and 0.25 parts of a charge controlling agent (BONTRON E-84 from Orient Chemical Industries Co., Ltd.) were mixed using a Q-type mixer (from Mitsui Mining Co., Ltd.) with setting the revolution of turbine blades to 50 m/sec. This mixing operation was performed for 2 minutes, followed by a pause for 1 minute. This cycle was repeated for 5 times, which resulted in the total mixing time of 10 minutes. Further, 0.5 parts of a hydrophobized silica (H2000 from Clariant Japan K.K.) were mixed therein with setting the revolution to 15 m/sec. This mixing operation was performed for 30 minutes, followed by a pause for 1 minute. This cycle was repeated for 5 times. Thus, a toner 4 was prepared.

### Example 5

The procedure for preparing the toner 4 in Example 4 was repeated except for changing the aging time to 10 hours. Thus, a toner 5 was prepared.

### Example 6

The procedure for preparing the toner 4 in Example 4 was repeated except for changing the aging temperature and time to 60° C. and 10 hours, respectively. Thus, a toner 6 was prepared.

### Example 7

To prepare an aqueous medium, 529.5 parts of ion-exchange water, 70 parts of the particulate resin dispersion 1, and 0.5 parts of sodium dodecylbenzenesulfonate were contained in a beaker and agitated using a TK HOMOMIXER at a revolution of 12,000 rpm. The resulting aqueous medium was mixed with 405.1 parts of the toner components liquid 3 for 30 minutes to prepare a dispersion slurry. The ethyl acetate in the dispersion slurry was removed until that the concentration fell below 0.9%.

The dispersion slurry was then aged for 2 hours at 50° C., and subjected to filtering, washing, drying, and classification using wind power. Thus, a mother toner was prepared.

Next, 100 parts of the mother toner and 0.25 parts of a charge controlling agent (BONTRON E-84 from Orient Chemical Industries Co., Ltd.) were mixed using a Q-type mixer (from Mitsui Mining Co., Ltd.) with setting the revolution of turbine blades to 50 m/sec. This mixing operation was performed for 2 minutes, followed by a pause for 1 minute. This cycle was repeated for 5 times, which resulted in the total mixing time of 10 minutes. Further, 0.5 parts of a hydrophobized silica (H2000 from Clariant Japan K.K.) were mixed therein with setting the revolution to 15 m/sec. This mixing operation was performed for 30 minutes, followed by a pause for 1 minute. This cycle was repeated for 5 times. Thus, a toner 7 was prepared.

### Example 8

The procedure for preparing the toner 7 in Example 7 was repeated except for changing the aging time to 5 hours. Thus, a toner 8 was prepared.

### Comparative Example 1

To prepare an aqueous medium, 529.5 parts of ion-exchange water, 70 parts of the particulate resin dispersion 1, and 0.5 parts of sodium dodecylbenzenesulfonate were contained in a beaker and agitated using a TK HOMOMIXER at a revolution of 12,000 rpm. The resulting aqueous medium was mixed with 405.1 parts of the toner components liquid 4 for 30 minutes to prepare a dispersion slurry. The ethyl acetate in the dispersion slurry was removed until that the concentration fell below 0.9%.

The dispersion slurry was then aged for 10 hours at 50° C., and subjected to filtering, washing, drying, and classification using wind power. Thus, a mother toner was prepared.

Next, 100 parts of the mother toner and 0.25 parts of a charge controlling agent (BONTRON E-84 from Orient Chemical Industries Co., Ltd.) were mixed using a Q-type mixer (from Mitsui Mining Co., Ltd.) with setting the revolution of turbine blades to 50 m/sec. This mixing operation was performed for 2 minutes, followed by a pause for 1 minute. This cycle was repeated for 5 times, which resulted in the total mixing time of 10 minutes. Further, 0.5 parts of a hydrophobized silica (H2000 from Clariant Japan K.K.) were mixed therein with setting the revolution to 15 m/sec. This mixing operation was performed for 30 minutes, followed by a pause for 1 minute. This cycle was repeated for 5 times. Thus, a toner 9 was prepared.

### Comparative Example 2

The procedure for preparing the toner 9 in Comparative Example 1 was repeated except for changing the aging time to 15 hours. Thus, a toner 10 was prepared.

### Comparative Example 3

To prepare an aqueous medium, 529.5 parts of ion-exchange water, 70 parts of the particulate resin dispersion 1, and 0.5 parts of sodium dodecylbenzenesulfonate were contained in a beaker and agitated using a TK HOMOMIXER at a revolution of 12,000 rpm. The resulting aqueous medium was mixed with 405.1 parts of the toner components liquid 5 for 30 minutes to prepare a dispersion slurry. The ethyl acetate in the dispersion slurry was removed until that the concentration fell below 0.9%.

The dispersion slurry was then aged for 2 hours at 50° C., and subjected to filtering, washing, drying, and classification using wind power. Thus, a mother toner was prepared.

Next, 100 parts of the mother toner and 0.25 parts of a charge controlling agent (BONTRON E-84 from Orient Chemical Industries Co., Ltd.) were mixed using a Q-type mixer (from Mitsui Mining Co., Ltd.) with setting the revolution of turbine blades to 50 m/sec. This mixing operation was performed for 2 minutes, followed by a pause for 1 minute.

This cycle was repeated for 5 times, which resulted in the total mixing time of 10 minutes. Further, 0.5 parts of a hydrophobized silica (H2000 from Clariant Japan K.K.) were mixed therein with setting the revolution to 15 m/sec. This mixing operation was performed for 30 minutes, followed by a pause for 1 minute. This cycle was repeated for 5 times. Thus, a toner 11 was prepared.

### Comparative Example 4

The procedure for preparing the toner 11 in Comparative Example 3 was repeated except for changing the aging temperature and time to 60° C. and 15 hours, respectively. Thus, a toner 12 was prepared.

### Comparative Example 5

To prepare an aqueous medium, 529.5 parts of ion-exchange water, 70 parts of the particulate resin dispersion 1, and 0.5 parts of sodium dodecylbenzenesulfonate were contained in a beaker and agitated using a TK HOMOMIXER at a revolution of 12,000 rpm. The resulting aqueous medium was mixed with 405.1 parts of the toner components liquid 6 for 30 minutes to prepare a dispersion slurry. The ethyl acetate in the dispersion slurry was removed until that the concentration fell below 0.9%.

The dispersion slurry was then aged for 1 hour at 50° C., and subjected to filtering, washing, drying, and classification using wind power. Thus, a mother toner was prepared.

Next, 100 parts of the mother toner and 0.25 parts of a charge controlling agent (BONTRON E-84 from Orient Chemical Industries Co., Ltd.) were mixed using a Q-type mixer (from Mitsui Mining Co., Ltd.) with setting the revolution of turbine blades to 50 m/sec. This mixing operation was performed for 2 minutes, followed by a pause for 1 minute. This cycle was repeated for 5 times, which resulted in the total mixing time of 10 minutes. Further, 0.5 parts of a hydrophobized silica (H2000 from Clariant Japan K.K.) were mixed therein with setting the revolution to 15 m/sec. This mixing operation was performed for 30 minutes, followed by a pause for 1 minute. This cycle was repeated for 5 times. Thus, a toner 13 was prepared.

### Comparative Example 6

The procedure for preparing the toner 13 in Comparative Example 5 was repeated except for changing the aging time to 10 hours. Thus, a toner 14 was prepared.

### Comparative Example 7

To prepare an aqueous medium, 529.5 parts of ion-exchange water, 70 parts of the particulate resin dispersion 1, and 0.5 parts of sodium dodecylbenzenesulfonate were contained in a beaker and agitated using a TK HOMOMIXER at a revolution of 12,000 rpm. The resulting aqueous medium was mixed with 405.1 parts of the toner components liquid 7 for 30 minutes to prepare a dispersion slurry. The ethyl acetate in the dispersion slurry was removed until that the concentration fell below 0.9%.

The dispersion slurry was then aged for 1 hour at 40° C., and subjected to filtering, washing, drying, and classification using wind power. Thus, a mother toner was prepared.

Next, 100 parts of the mother toner and 0.25 parts of a charge controlling agent (BONTRON E-84 from Orient Chemical Industries Co., Ltd.) were mixed using a Q-type mixer (from Mitsui Mining Co., Ltd.) with setting the revolution of turbine blades to 50 m/sec. This mixing operation was performed for 2 minutes, followed by a pause for 1 minute. This cycle was repeated for 5 times, which resulted in the total mixing time of 10 minutes. Further, 0.5 parts of a hydrophobized silica (H2000 from Clariant Japan K.K.) were mixed therein with setting the revolution to 15 m/sec. This mixing operation was performed for 30 minutes, followed by a pause for 1 minute. This cycle was repeated for 5 times. Thus, a toner 15 was prepared.

### Comparative Example 8

The procedure for preparing the toner 15 in Comparative Example 7 was repeated except for changing the aging temperature and time to 50° C. and 5 hours, respectively. Thus, a toner 16 was prepared.

The properties of the above-prepared toners 1 to 16 are shown in Tables 1-1 and 1-2.

TABLE 1-1

| | | | | Ratio of | |
|---|---|---|---|---|---|
| | | | | particles | |
| | | Particle size | | with a diameter | Average |
| | Toner | Dv | Dv/ | 2 μm or less | circularity |
| | No. | (μm) | Dn | (% by number) | (*) |
| Example 1 | 1 | 5.2 | 1.14 | 1.8 | 0.97 |
| Example 2 | 2 | 5.2 | 1.14 | 2.0 | 0.97 |
| Example 3 | 3 | 5.6 | 1.15 | 1.9 | 0.97 |
| Example 4 | 4 | 5.4 | 1.14 | 1.5 | 0.97 |
| Example 5 | 5 | 5.5 | 1.14 | 2.1 | 0.97 |
| Example 6 | 6 | 5.7 | 1.15 | 1.8 | 0.97 |
| Example 7 | 7 | 5.5 | 1.15 | 1.9 | 0.98 |
| Example 8 | 8 | 5.8 | 1.15 | 2.0 | 0.98 |
| Comparative | 9 | 5.3 | 1.14 | 1.7 | 0.97 |
| Example 1 | | | | | |
| Comparative | 10 | 5.3 | 1.14 | 1.9 | 0.97 |
| Example 2 | | | | | |
| Comparative | 11 | 5.4 | 1.14 | 2.1 | 0.97 |
| Example 3 | | | | | |
| Comparative | 12 | 5.4 | 1.14 | 2.0 | 0.97 |
| Example 4 | | | | | |
| Comparative | 13 | 5.5 | 1.15 | 1.9 | 0.98 |
| Example 5 | | | | | |
| Comparative | 14 | 5.7 | 1.15 | 1.8 | 0.98 |
| Example 6 | | | | | |
| Comparative | 15 | 5.8 | 1.16 | 1.8 | 0.98 |
| Example 7 | | | | | |
| Comparative | 16 | 5.8 | 1.16 | 1.9 | 0.98 |
| Example 8 | | | | | |

(*) Average circularity = Cs/Cp, wherein Cp represents the length of the circumference of a projected image a particle and Cs represents the length of the circumference of a circle having the same area as that of the projected image of the particle.

TABLE 1-2

| | | Acid | | B(**) | P(***) |
|---|---|---|---|---|---|
| | Toner | value | Tg | (% by | (% by |
| | No. | (mgKOH/g) | (° C.) | weight) | weight) |
| Example 1 | 1 | 18.5 | 51.2 | 6.4 | 20 |
| Example 2 | 2 | 18.4 | 52.4 | 6.4 | 75 |
| Example 3 | 3 | 18.2 | 53.5 | 6.4 | 95 |
| Example 4 | 4 | 18.5 | 54.6 | 19.2 | 20 |
| Example 5 | 5 | 18.7 | 55.0 | 19.2 | 80 |
| Example 6 | 6 | 18.4 | 56.5 | 19.2 | 95 |
| Example 7 | 7 | 18.2 | 57.4 | 40.9 | 20 |
| Example 8 | 8 | 18.5 | 58.2 | 40.9 | 95 |
| Comparative | 9 | 18.3 | 50.1 | 5.4 | 15 |
| Example 1 | | | | | |
| Comparative | 10 | 18.6 | 51.2 | 5.4 | 95 |
| Example 2 | | | | | |
| Comparative | 11 | 18.6 | 53.0 | 21.1 | 15 |
| Example 3 | | | | | |
| Comparative | 12 | 18.5 | 54.2 | 21.1 | 99 |
| Example 4 | | | | | |
| Comparative | 13 | 18.3 | 56.9 | 40.9 | 15 |
| Example 5 | | | | | |
| Comparative | 14 | 18.4 | 57.1 | 40.9 | 99 |
| Example 6 | | | | | |
| Comparative | 15 | 18.3 | 58.1 | 50.7 | 20 |
| Example 7 | | | | | |
| Comparative | 16 | 18.2 | 59.5 | 50.7 | 99 |
| Example 8 | | | | | |

(**)B: Ratio of second binder resin in toner
(***)P: Ratio of organic-solvent-insoluble components in second binder resin

The above-prepared toners 1 to 16 were subjected to the following evaluation tests.

### A) Evaluation of Fixing Properties

Each of the toners and a paper TYPE 6200 (from Ricoh Co., Ltd.) were set in a modified copier MF2200 (from Ricoh Co., Ltd.) employing a fixing roller using TEFLON®. Images were produced while varying the temperature of the fixing roller to determine the minimum fixable temperature below which low-temperature offset occurs and the maximum fixable temperature above which high-temperature offset occurs. When determining the minimum fixable temperature, the paper feeding speed was set to 120 to 150 mm/sec, the surface pressure was set to 1.2 Kgf/cm², and the nip width was set to 3 mm. When determining the maximum fixable temperature, the paper feeding speed was set to 50 mm/sec, the surface pressure was set to 2.0 Kgf/cm², and the nip width was set to 4.5 mm.

Low-temperature fixability was evaluated by the minimum fixable temperature and was graded into the following 5 levels.

A: The minimum fixable temperature was less than 140° C.

B: The minimum fixable temperature was from 140 to 149° C.

C: The minimum fixable temperature was from 150 to 159° C.

D: The minimum fixable temperature was from 160 to 170° C.

B: The minimum fixable temperature was greater than 170° C.

High-temperature offset resistance was evaluated by the maximum fixable temperature and was graded into the following 5 levels.

A: The maximum fixable temperature was greater than 201° C.

B: The maximum fixable temperature was from 191 to 200° C.

C: The maximum fixable temperature was from 181 to 190° C.

D: The maximum fixable temperature was from 171 to 180° C.

E: The maximum fixable temperature was 170° C. or less.

### B) Evaluation of Heat-Resistant Storage Stability

Each of the toners was left for 8 hours at 50° C., and subsequently filtered with a 42 mesh for 2 minutes. Heat-resistant storage stability was evaluated by the residual ratio of the toner on the mesh after the 2-minute filtering and was graded into the following 4 levels.

A: The residual ratio was less than 10%.

B: The residual ratio was from 10 to 20%.

C: The residual ratio was from 20 to 30%.

D: The residual ratio was greater than 30%.

The evaluation results are shown in Table 2.

TABLE 2

| | | Low-temperature | High-temperature | Heat- |
|---|---|---|---|---|
| | | fixability/ | offset resistance/ | resistant |
| | Toner | Minimum Fixable | Maximum Fixable | storage |
| | No. | Temperature | Temperature | stability |
| Example 1 | 1 | A/125° C. | B/195° C. | B |
| Example 2 | 2 | A/130° C. | B/195° C. | B |
| Example 3 | 3 | A/130° C. | B/195° C. | A |
| Example 4 | 4 | A/135° C. | B/200° C. | B |
| Example 5 | 5 | A/135° C. | A/210° C. | A |
| Example 6 | 6 | B/140° C. | A/210° C. | A |
| Example 7 | 7 | B/145° C. | A/210° C. | A |
| Example 8 | 8 | B/145° C. | A/220° C. | A |
| Comparative | 9 | A/125° C. | E/170° C. | E |
| Example 1 | | | | |
| Comparative | 10 | A/125° C. | D/180° C. | E |
| Example 2 | | | | |
| Comparative | 11 | A/130° C. | C/185° C. | D |
| Example 3 | | | | |
| Comparative | 12 | C/150° C. | A/210° C. | A |
| Example 4 | | | | |
| Comparative | 13 | B/145° C. | D/180° C. | D |
| Example 5 | | | | |
| Comparative | 14 | D/165° C. | A/210° C. | A |
| Example 6 | | | | |
| Comparative | 15 | D/170° C. | A/220° C. | A |
| Example 7 | | | | |
| Comparative | 16 | E/185° C. | A/220° C. | A |
| Example 8 | | | | |

In Comparative Example 1 (Toner 9), high-temperature offset resistance and heat-resistant storage stability are poor because the ratio B (% by weight) of the second binder resin in the toner and the ratio P (% by weight) of organic-solvent-insoluble components in the second binder resin are 5.4% by weight and 15% by weight, respectively.

In Comparative Example 2 (Toner 10), high-temperature offset resistance and heat-resistant storage stability are poor because the ratio B (% by weight) of the second binder resin in the toner is 5.4% by weight.

In Comparative Example 3 (Toner 11), heat-resistant storage stability is poor because the ratio P (% by weight) of organic-solvent-insoluble components in the second binder resin is 15% by weight.

In Comparative Example 4 (Toner 12), low-temperature fixability is poor because the ratio P (% by weight) of organic-solvent-insoluble components in the second binder resin is 99% by weight.

In Comparative Example 5 (Toner 13), high-temperature offset resistance and heat-resistant storage stability are poor because the ratio P (% by weight) of organic-solvent-insoluble components in the second binder resin is 15% by weight.

In Comparative Example 6 (Toner 14), low-temperature fixability is poor because the ratio P (% by weight) of organic-solvent-insoluble components in the second binder resin is 99% by weight.

In Comparative Example 7 (Toner 15), low-temperature fixability is poor because the ratio B (% by weight) of the second binder resin in the toner is 50.7% by weight.

In Comparative Example 8 (Toner 16), low-temperature fixability is poor because the ratio B (% by weight) of the second binder resin in the toner and the ratio P (% by weight) of organic-solvent-insoluble components in the second binder resin are 50.7% by weight and 99% by weight, respectively.

In Examples 1 to 8 (Toners 1 to 8), low-temperature fixability, high-temperature offset resistance, and heat-resistant storage stability are all good because the ratio B (% by weight) of the second binder resin in the toner and the ratio P (% by weight) of organic-solvent-insoluble components in the second binder resin are 6.4 to 40.9% by weight and 20 to 95% by weight, respectively.

Having now fully described the invention, it will be apparent to one of ordinary skill in the art that many changes and modifications can be made thereto without departing from the spirit and scope of the invention as set forth therein.

What is claimed is:

1. A toner, comprising:
a first binder resin;
a second binder resin that is a reaction product of a compound having an active hydrogen group with a polymer reactive with the active hydrogen group;
a colorant; and
a release agent,
wherein the toner includes the second binder resin in an amount of from 6.4 to 40.9% by weight, and
wherein the reaction product includes organic-solvent-insoluble components in an amount of from 20 to 95% by weight.

2. The toner according to claim 1, wherein the polymer reactive with the active hydrogen group has a weight average molecular weight of from 10,000 to 200,000.

3. The toner according to claim 1, wherein the first binder resin comprises an unmodified polyester resin.

4. The toner according to claim 3, wherein the first binder resin comprises the unmodified polyester resin in an amount of from 50 to 100% by weight.

5. The toner according to claim 3, wherein the unmodified polyester resin includes tetrahydrofuran-soluble components having a weight average molecular weight of from 1,000 to 30,000.

6. The toner according to claim 3, wherein the unmodified polyester resin has an acid value of from 1.0 to 50.0 mgKOH/g.

7. The toner according to claim 3, wherein the unmodified polyester resin has a glass transition temperature of from 35 to 65° C.

8. The toner according to claim 1, wherein the toner has an acid value of from 0.5 to 40.0 mgKOH/g.

9. The toner according to claim 1, wherein the toner has a glass transition temperature of from 40 to 70° C.

10. The toner according to claim 1, wherein the toner has a volume average particle diameter of from 3 to 7 μm.

11. The toner according to claim 1, wherein a ratio (Dv/Dn) of a volume average particle diameter (Dv) to a number average particle diameter (Dn) of the toner is 1.20 or less.

12. The toner according to claim 1, wherein the toner includes toner particles having a particle diameter of 2 μm or less in an amount of from 1 to 10% by number.

13. A method of manufacturing toner, comprising:
dissolving or dispersing a first binder resin, a compound having an active hydrogen group, a polymer reactive with the active hydrogen group, a colorant, and a release agent in an organic solvent to prepare a toner components liquid;
dispersing the toner components liquid in an aqueous medium containing a particulate resin to prepare oil droplets, while reacting the compound having an active hydrogen group with the polymer reactive with the active hydrogen group to form a second binder resin;
removing the organic solvent from the oil droplets to prepare a toner; and
washing and drying the toner,
wherein the toner includes the second binder resin in an amount of from 6.4 to 40.9% by weight, and
wherein the reaction product includes organic-solvent-insoluble components in an amount of from 20 to 95% by weight.

14. The method of manufacturing toner according to claim 13, further comprising controlling temperature and time while the compound having an active hydrogen group reacts with the polymer reactive with the active hydrogen group.

15. A toner manufactured according to the method of claim 13.
